(19) United States
(12) Patent Application Publication
(10) Pub. No.: US 2006/0256645 A1
(43) Pub. Date: Nov. 16, 2006

(54) Treatment of particle-bearing liquid

(75) Inventors: Soren Greve Jensen, Slagelese (DK); Henning Enevoldsen, Rodovre (DK)

Correspondence Address: REINHART BOERNER VAN DEUREN P.C., 2215 PERRYGREEN WAY, ROCKFORD, IL, 61107, US

(73) Assignee: Invensys Process System A/S, Silkeborg (DK)

(21) Appl. No.: 11/416,815

(22) Filed: May 3, 2006

Related U.S. Application Data
(63) Continuation of application No. PCT/IB04/03190, filed on Nov. 1, 2004.

(30) Foreign Application Priority Data
Nov. 3, 2003 (GB) 0325580.9
Jan. 21, 2004 (GB) 0401271.2

(51) Int. Cl. B01F 15/02

(52) U.S. Cl. 366/131

(57) ABSTRACT

A system for treatment of particle bearing liquid is provided. The system comprises control means and an homogeniser valve, said control means being operable to cause a gap defined by the homogeniser valve to be periodically temporarily increased thereby to allow any accumulated particulate matter to pass through the valve, the valve then continuing to provide an homogenisation of subsequently flowing liquid when the valve returns to its normal mode of operation.

### CROSS-REFERENCE TO RELATED PATENT APPLICATIONS

This patent application is a continuation of co-pending International Application No. PCT/IB2004/003190, filed Nov. 1, 2004 the teachings and disclosure of which are hereby incorporated in their entireties by reference thereto.

### FIELD OF THE INVENTION

This invention relates to a system and method for treatment of particle bearing liquid and in particular, but not exclusively, the treatment of sludge in a wastewater facility.

### BACKGROUND OF THE INVENTION

Industrial and municipal entities treat wastewater to prevent the contamination and pollution of local receiving waters and potable water supplies. Such treatment facilities are designed to remove inorganic and organic pollutants from the wastewater using various biological aerobic and anaerobic processes.

In general, industrial and municipal entities incur substantial costs in the operation of these wastewater treatment facilities. In addition to utility costs to operate the necessary machinery and mechanical systems, a facility also typically incurs substantial costs for the disposal of waste sludge generated by the various treatment processes. Sludge produced during wastewater treatment includes primary sludge from the pre-purification stage and biologically activated sludge from aerobic digestion. Stabilised sludge may be produced through the subsequent application of anaerobic digestion of biologically activated sludge with or without the addition of primary sludge. In some wastewater treatment facilities, these sludges are disposed by incineration, landfill, or spread as fertilizer over agricultural fields. All of these disposal methods result in expensive costs to the facility. Based on these substantial operational and disposal costs, it would be desirable to optimise the energy consumption for processing the wastewater and sludge to attain an improved quality of wastewater discharge and/or reduction in sludge disposal costs.

Anaerobic digestion is a microbiological process in which organic materials are broken down by the action of microorganisms in the absence of oxygen. The anaerobic microorganisms reduce the quantity of organic matter present in the biologically activated sludge thereby generating bio-gas having a relatively high methane gas content. The stabilised sludge is typically removed from a digestion tank for dewatering and disposal. The methane gas can be burned off or recovered to supply energy to heat the digesters as well as supply energy for use elsewhere in the treatment facility.

In dewatering processes, water is mechanically squeezed or separated from the sludge stream. Most advancements in this field of technology have sought to optimise the energy consumed in processing the sludge with the reduction in the volume of sludge disposed. Additionally the disruption technologies have sought to optimise the mass reduction of sludge for disposal.

An overview of conventional disruption methods can be found in a publication by N. Dichtl, J. Muller, E. Engelmann, F. Gunthert, M. Osswald entitled, Desintegration von Klärschlamm—ein aktueller Überblick in: Korrespondenz Abwasser, (44) No. 10, pp. 1726-1738 (1997). This publication describes three mechanical disruption techniques: (1) stirred ball mills; (2) high-pressure homogenisers; and (3) ultrasonic homogenisers. With the aid of these disruption methods, the microorganisms and particulate solids in sludge are essentially comminuted or chopped-up. For example, the cellular walls of microorganisms and particulates present in sludge may be destroyed when the external pressure exceeds the cell internal pressure with the use of a homogeniser. The cell contents, which are separated from the exterior by the cell wall, are thereby released and become available for subsequent digestion.

An advantage of these disruption processes when applied to sludge is that the anaerobic micro-organisms are also disrupted together with the aerobic micro-organisms, in contrast to other methods in which such micro-organisms at least partly survive the disruption process. They remain in the disposed sludge as organic residue. A second advantage of disruption is that organic substances contained within the cellular contents of the sludge are released to the micro-organisms during the disruption process. In this way, they serve as internal sources of carbon to support de-nitrification in the digestion process.

Another publication concerning disruption of primary sludge using ultrasonic homogenisers is described in G. Lehne, J. Muller: “The Influence Of The Energy Consumption On The Sewage Sludge Disruption,” Technical University Hamburg—Harburg Reports On Sanitary Engineering, No. 25, pp. 205-215 (1999). The Lehne et al. publication describes that cell disruption is greater when the amount of cavitation bubbles in the vicinity of an ultrasonic probe is higher. The amount of cavitation bubbles is proportional to the intensity of the ultrasonic probe. Further study of the optimisation of the ultrasonic probe intensities was necessary in order to optimise the energy balance. A comparison of the ultrasonic homogeniser with high-pressure homogeniser and ball stirring mill provided comparable results in this process. However, mechanical problems, due to coarse material, occurred in the high-pressure homogeniser and ball stirring mill.

Disruption of the organic content in stabilised sewage sludge is also described in H. Gruning: “Einfluss des Aufschlusses von Faulschlammen auf das Restgaspotential.” This article describes that, in processing anaerobic stabilised sewage sludge, gas production is considerably increased by prior disruption using ultrasound. An article by J. Muller, N. Dichtl, J. Schwedes, “Klarschlammdesintegration—Forschung und Anwendung”, Publication of the Institute for Settlement Water Economy of the Technical University Braunschweig, No. 61, Conference on the 10th and 11th of March 1998 in Braunschweig, pp. 180-191 (March 1998) discloses the use of a high-pressure homogeniser to disrupt stabilised sludge at pressures in the range of 500 to 1000 bar. Accordingly, they subscribe to conventional wisdom, which dictates that increased homogeniser pressures should be employed in order to increase the degree of disruption of the microbial sludge cells. Under this assumption, the amount of cell disruption increases in proportion to the degree of energy input. Accordingly, attempts so far have generally been directed to the application of disruption and/or anaerobic digestion of unconcentrated biologically activated sludge to reduce volume which has to be disposed.

A general description of the effects of sludge concentration and disruption of stabilised sludge can be found in T. Onyeche, O. Schläfer, H. Klotzbucher, M. Sievers, A. Vogelpohl: “Verbesserung der Energiebilanz durch Feststoffseparation bei einem kombinierten Verfahren aus Klarschlammdesintegration und Vergarung, DechemaJahrestagungen 1998, Volume II, pp. 117-118 (1998). This article teaches that the sludge solids content can be concentrated using a decanter and thereafter homogenized. However, the high-pressure homogenisers used in this reference are operated at pressures of at least 500 bar. In any event, this article fails to adequately solve problem of optimizing the energy balance of the system.

U.S. Pat. No. 6,013,183, the teachings and disclosure of which are hereby incorporated in their entireties by reference thereto, which issued Jan. 11, 2000, discloses the application of high pressure homogenisation to biologically activated sludge. The sludge is homogenised at a pressure drop in excess of 5000 PSI (350 bar) across the homogenisation nozzle as a means of improving the reduction of volatile total solids when the liquefied biological activated sludge is recycled back to the aerobic digester. The patent also discloses the application of high pressure homogenisation of biologically activated sludge prior to anaerobic digestion, but it fails to address what, if any, treatment should be applied to primary sludge, or to further processing of stabilised sludge. Moreover, the issue of achieving a positive energy balance, such as through prior concentration of the sludge, is not addressed.

U.S. Pat. No. 4,629,785, which issued Dec. 16, 1986, disclosed the application of high pressure homogenisation to both biologically activated sludge and stabilised sludge at pressures of up to 12,000 PSI (825 bar) prior to recovery of proteins in the sludge. This patent similarly excludes treatment of primary sludge and does not address energy recovery through production of methane gas during anaerobic digestion of the liquefied sludge.

Notwithstanding the above-described methods for treating sludge, a need for optimising the energy balance of the disruption process to minimize energy costs exists. The possible benefit of concentrating sludge prior to homogenisation has not previously been disclosed. In optimising the energy balance, it would be desirable to determine when the energy required to disrupt and otherwise pretreat primary and/or secondary sludge is about the same as, or considerably lower than, the energy obtained through additional methane gas yield. In this regard, it would also be desirable to optimise the disruption process in such a manner that the methane gas produced during the sludge digestion processes can be used as a source of energy to self-sustain the disruption process as well as other treatment processes. Accordingly, there is a need for a wastewater treatment system that positively balances the energy required to disrupt a sludge stream with the energy yield due to an increased production of methane gas (which can be converted to electrical energy).

### BRIEF SUMMARY OF THE INVENTION

Accordingly, it is a general object of an embodiment of the present invention to overcome the deficiencies in the wastewater treatment art.

It is another object of an embodiment of this invention to optimise the energy balance associated with the energy consumed for processing of sludge produced during wastewater treatment and the energy yield obtained from the increased production of methane gas during anaerobic digestion of sludge.

It is a further object of an embodiment of the present invention to provide a system and method that disrupts cellular walls of micro-organisms present in stabilised sludge in order to release nutrients for enhancing the sludge digestion process, and thus reducing the mass of stabilised sludge which must be disposed.

These and other additional objects and advantages are achieved in a unique combination of methods and systems for treating sludge generated in a waste water treatment facility according to the present invention. The method comprises increasing the solids concentration in primary, biologically activated, and stabilised sludge or any mixture thereof which undergoes anaerobic digestion. In a preferred embodiment, a homogeniser, operating within an economically viable low-pressure range, then disrupts the cellular walls of the various microorganisms in the concentrated sludge, thereby releasing nutrients from within the cells. Disruption can occur either continuously or discontinuously. The disrupted sludge is subsequently supplied to a digestion tank, providing additional nutrients to enhance the production of methane gas. In this way, the invention optimises the energy demand in concentrating and homogenising the sludge as compared with the energy yield from the increased production of methane gas generated during the digestion process.

In accordance with another aspect of an embodiment of the invention, a positive energy balance is achieved with the use of a concentrated sludge having a high solids concentration that is processed under a reduced homogeniser pressure. The sludge is preferably concentrated by a factor of about 1.5 or greater prior to being processed with a homogeniser. Also, the homogeniser is preferably operated at a low-pressure range of less than 400 bar. In this range, the disruption step operates self-sufficiently, and even provides excess energy. This invention ascertained that the high-pressure homogeniser should advantageously be operated at a pressure of 50 to 400 bar, where the optimum is at the lower range of 100 or 200 bar. As explained below, even lower pressures may be achieved with the use of particular equipment, such as the APV Micro-Gap or Super Micro-Gap range of homogeniser valves.

In accordance with another alternative feature of an embodiment of the invention, the sludge undergoes a classification process prior to disruption. In this way, solid material particles are removed from the sediment sludge before they reach the homogeniser. The efficiency of homogenisation is improved in this manner. For example, classification of the sludge can take place with the use of a wet sieve device or sieve.

One embodiment of the present invention is directed to a method and system which makes use of a high pressure homogeniser.

Homogenisers require, in order to achieve homogenisation, that a liquid, such as sludge, is forced at high pressure through a small gap. Typically the gap is 0.05 mm or less, a gap of 0.03 mm typically being employed. Also, typically, the pressure of liquid directed to the homogeniser is 500 psi or greater, though a lower pressure may be used in a manner for example as described in relation to the invention the subject of said International patent publication WO 01/16037.

Because of the small size of the gap through which liquid must flow in order to achieve homogensation, in the case of liquid waste material which, in contrast to relatively pure liquids such as milk, inherently tends to incorporate particulate matter such as grit, there is risk of the homogeniser becoming blocked. To attempt to alleviate the occurrence of blockages the waste liquid may first be passed through a macerator or like device, or alternative means such as a settling tank or centrifuge. However it is found that despite employing such devices or techniques there still remains the potential problem of the homogeniser valve becoming blocked.

Another embodiment of the present invention is directed to the provision of a system and method which allows an homogeniser valve to be operated substantially continuously in, for example, a wastewater treatment facility.

In accordance with an embodiment of the present invention there is provided a system and method in which the gap defined by the homogeniser valve is periodically temporarily increased thereby to allow any accumulated particulate matter to pass through the valve, the valve then continuing to provide an homogenisation of subsequently flowing liquid when the valve returns to its normal mode of operation.

Opening of the valve may be controlled by control means which may be built into or attached to the valve, or by control means located in another part of a system in which the valve is incorporated.

The present invention envisages that the valve is opened to allow passage of any accumulated particulate material for a period which is less than 10%, more preferably less than 5% of the period for which it has been operating in a normal mode. More preferably it remains in said relatively open position for less than 2% of the period for which it is in the normal homogenisation mode; a percentage of 1% is believed to be particularly suitable and sufficient.

If the valve is being used in a wastewater treatment system which incorporates a macerator, the gap provided by the valve when moved to said relatively open position preferably is slightly greater than the maximum size of solid material passing through the macerator. Thus a 10 mm valve gap would be appropriate for use in a system which incorporates a macerator which chops particulate material to a maximum size of 8 mm. The gap when fully open preferably is at least 10%, more preferably at least 25% greater than the maximum particle size. A percentage in the range 5% to 40%, more preferably 10% to 30% may be employed.

It will thus be appreciated that an embodiment of the present invention envisages use of an homogeniser valve which differs from many conventionally known homogeniser valves in so far as it is able to open to a much greater extent. Typically homogeniser valves as used in the dairy processing industry are not forcibly opened in a controlled manner, but open only as a result of the pressure drop acting across the valve. In consequence the valve tends to open only to a gap size which results in the pressure drop becoming insignificant. In most cases this equates to a valve opening gap of less than 1 mm. In contrast the present invention teaches that use may be made of a valve openable to a significantly greater extent. The ratio between the gap in said open position and in the normal operating positions for homogenisation preferable is at least 100:1, more preferably at least 200:1.

Although an embodiment of the invention is directed to homogenisation of wastewater sludge, it may be employed in other types of processes which require high pressure homogenisation of any liquid, such as an emulsion or dispersion or other form of liquid which contains particles that cannot pass through a normal homogensation valve and where there is no need to homogenise 100% of the emulsion or dispersion. That is, an embodiment of the present invention teaches that by allowing a small amount of sludge or other liquid to pass unhomogenised through a homogenizer valve it is possible to reduce the risk of blockage so that a larger amount of sludge or other liquid can be homogenized. In the case of sludge treatment, whether for concentrated or non concentrated sludge, the larger amount of sludge which is homogenized allows for an increase in biogas production and a reduction in the amount of sludge remaining for disposal.

Control of the gap provided by the homogenisation valve may be achieved by an hydraulic or pneumatic actuator, which actuator optionally may be integrated within the valve. Hydraulic or pneumatic pressure may be used for the purpose of decreasing and increasing the valve gap, or hydraulic pressure may be used for just one of those movements, and the opposite movement may be, for example, achieved by provision of spring means.

Pressure and/or fluid sensors may be provided in the liquid flow path to and/or from the homogeniser valve and information from said sensors may be utilised to detect the presence or onset of a blockage and cause temporary opening of the valve. Alternatively or additionally, the valve may be automatically temporarily moved to said relatively open position a regular basis at fixed intervals of time. The period for which the valve is in said relatively open position may be predetermined or may be variable, for example having regard to information provided by said sensors.

The valve may be of kind comprising a valve seat and a valve closure member moveable one relative to the other to vary the gap through which fluid may flow for homogenisation. One or each of the valve seat and closure member may be arranged to be relatively readily removable for replacement in the event of wear arising in consequence of abrasion by particulate matter contained in the liquid flowing through the valve. In a preferred construction the closure member is arranged to be selectively removable from the end of an actuating rod by gaining access via an outlet port of the homogeniser, thereby avoiding the need to dismantle the homogeniser for replacement of the closure member.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified block diagram representation of a wastewater treatments system according to one embodiment of the present invention;

FIG. 2 is a block diagram representation of a wastewater treatment system according to a second embodiment the present invention;

FIG. 3 is a flow diagram illustrating the energy flow associated with the embodiments shown in FIGS. 1 and 2;

FIG. 4 is a graph illustrating the energy balance for unconcentrated sludge and for concentrated sludge that has been disrupted using a homogeniser operated at various operating pressures;

FIG. 5 is a graph illustrating gas production over a period of time for non-disrupted sludge and disrupted sludge at various concentrations at a first operating pressure;

FIG. 6 is a graph illustrating gas production over a period of time for non-disrupted and disrupted sludge at various concentrations at a second operating pressure;

FIG. 7 is a graph illustrating gas production over a period of time for non-disrupted and disrupted sludge at various concentrations at a third operating pressure;

FIG. 8 is a simplified block diagram representation of a wastewater treatment system in accordance with an other embodiment of the present invention; and

FIG. 9 is a cross-sectional view illustration of a homogeniser valve for use in the system of FIG. 8.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

One example of a type of system and method to which the present invention may be applied is that which is described and claimed in the specification of International Patent Publication WO 01/16037 having International Application Number PCT/IB00/01194, the teachings and disclosure of which are hereby incorporated in their entireties by reference thereto.

In general, an embodiment of the present invention provides a method and system for optimizing the energy balance associated with the energy consumed for treatment of waste water sludge prior to anaerobic digestion and the energy yielded from such treatment in the form of methane gas production. In accordance with the invention, activated sludge is mechanically disintegrated or disrupted to release nutrients that enhance the digestion process. In this manner, anaerobic digestion of the disrupted sludge is improved, resulting in decreased digestion time, decreased solids concentration, and increased production of methane gas. The resultant methane gas may preferably be converted into energy to self-sustain operation of the disruption system, as well as supply energy to other aspects and subsystems in the wastewater treatment facility.

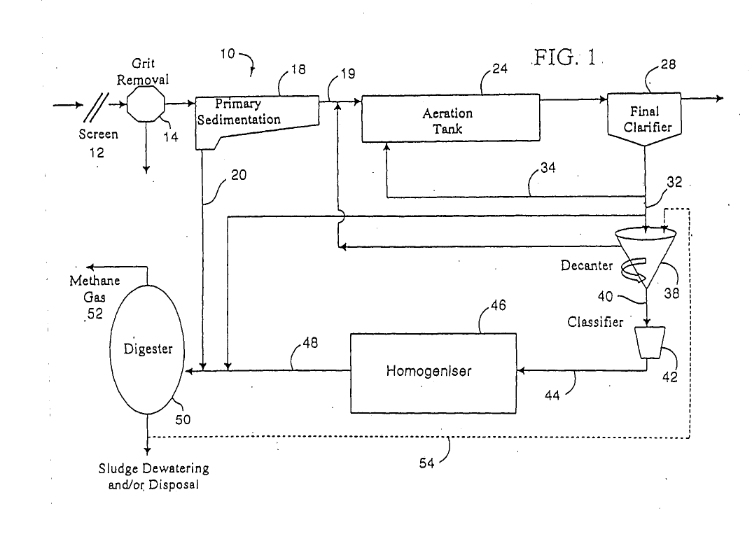

By way of background, a wastewater treatment system cleans wastewater before it is discharged into a receiving stream. FIG. 1 is a schematic block diagram of one such wastewater treatment system 10 that may be used by a municipality or the like. Typically, industrial or municipal wastewater initially passes along a flow path through a bar screen 12 and other grit removal apparatus 14 for removing such materials as grit that may otherwise be harmful to equipment employed in subsequent treatment of the wastewater. Next, the filtered wastewater empties into a primary sedimentation tank 18 to settle out the heavy sediments, which are typically inorganic. This waste material is sometimes referred to by those skilled in the art as primary sludge. In many implementations, the primary sludge is passed to a digester 50 for decomposition as indicated by a flow path 20.

The primary effluent flows from the primary sedimentation tank 18 to an aeration tank or basin 24 along a flow path 19 where the raw wastewater is treated with microorganisms in the presence of dissolved oxygen. In general, the aerobic microorganisms consume the organic particulates suspended in the wastewater. In this way, the treatment microorganisms reduce contaminants present in the wastewater as well as the biological oxygen demand.

For settling solid sludge containing the microorganisms, the mixed liquor flows from the aeration tank 24 into a final clarifier 28. In this stage of the process, flocculation and gravity settling separate the water from suspended particulates and solids, known as biologically activated (or secondary) sludge.

Settled sludge is removed from the final clarifier 28 and typically follows various flow paths. For example, some of the sludge may be pumped back into the aeration tank 24 along a flow path 34 to seed the growing system. The activated sludge that is recirculated to the aeration tank 24 is sometimes called return biologically activated sludge. At least a certain amount of excess sludge exiting the final clarifier 28 may also pass to an anaerobic digester 50 for digestion along a flow path 32.

In accordance with one embodiment of the present invention, a processing step is applied to the sludge entering anaerobic digestion apparatus for providing a greater concentration of solids in the sludge prior to disruption and digestion thereof. As shown in FIG. 1, before the sludge is disrupted and emptied into the digester 50 for digestion, at least a partial stream undergoes treatment in a decanter 38 and a classifier 42. The decanter 38 is typically a centrifuge or other circular motion device that rapidly separates the liquid phase from the solid phase of the sludge stream supplied thereto. In a preferred embodiment, the decanter 38 concentrates the solids in the sludge by a factor of at least 1.5. The decanted water that is separated from the waste activated sludge can be returned to the headworks or inlet waste water treatment stream for further processing.

Following the decanting step, the concentrated sludge is passed to a classifier 42 along a flow path 40. The classifier 42 removes troublesome materials (e. g., grit) that may be harmful to the ensuing high-pressure homogeniser 46 and/or harmful to agricultural landspreading. Thereby, the reliability of the operation of the high-pressure homogeniser 46 is improved and the disruption efficiency of the sludge is increased. An example of a classifier 42 is a grit vortex device, which utilizes rotary motion and gravity settling to separate the heavy solids from the lighter materials in the sludge stream. The order of the decanting and classifying steps in the process may be reversed.

For breaking up microorganisms in the concentrated sludge with a desired applied shear force, the concentrated (and preferably classified) sludge is preferably supplied to a high-pressure homogeniser 46 along a flow path 44. The high-pressure homogeniser 46 consists of a high-pressure pump and homogenizing valve as will be understood by those skilled in the art. In general, such homogenisers employ high pressure pumps which force fluid, in this case concentrated sludge, through a valve or nozzle having a restricted flow area. As the fluid flows through the restriction, the velocity increases and the pressure decreases as high-pressure potential energy is converted to kinetic energy. In one preferred embodiment, the homogeniser valve is implemented as an APV homogenizing valve, marketed under the tradename of Micro-Gap or Super Micro-Gap. The Super Micro-Gap homogenising valve is generally described in U.S. Pat. No. 5,749,650, issued on May 12, 1998, and in U.S. Pat. No. 5,899,564, issued on May 4, 1999. The subject matter of these patents is incorporated herein by reference in their entirety. With this implementation, the invention may achieve an even greater operating efficiency. That is, the SuperMicro-Gap homogenizing valve may provide operation at about a 20 percent reduction in pressure (and with a concommitent lower energy input) as compared with other homogenizing valves and still achieve the same amount of disruption.

The high-pressure pump in homogeniser 46 pressurizes and compresses the received sludge stream. The pressure on the sludge stream is subsequently reduced by the ambient pressure through a gap in the adjustable valve body of the homogenizing valve (not shown). As the pressure is reduced, the liquid velocity of the sludge stream is considerably increased. In a preferred embodiment, the pressure is reduced to the point that the steam pressure of the liquid remaining in the sludge stream is reached, forming steam bubbles or cavitation bubbles. The steam bubbles further increase the flow velocity of the sludge stream to the point of supersonic flow, leading to cavitation thrusts. Ultimately, the cavitation bubbles collapse and energy-rich friction velocity fields are formed, causing the cellular contents of the microorganisms in the sludge to be disrupted. Upon exiting the homogeniser valve, the sludge stream passes through an impact ring to reduce the flow velocity of the suspension.

For decomposition thereof, the disrupted sludge stream is then provided along a flow path 48 to a digester 50. Particularly with anaerobic digestion, one of the byproducts of the digestion process is methane gas. The methane gas can be recovered (such as along flow path 52) and converted to energy, particularly electrical energy. In this way the converted energy may be used to operate the various electrical devices and subsystems utilized in the wastewater treatment system. The stabilized, digested sludge typically undergoes further dewatering treatment and is thereafter disposed. As shown in FIG. 1, stabilized, digested sludge may optionally be returned from the anaerobic digester 50 to the decanter along the flow path 54. Ultimately, the sludge is disrupted by the high-pressure homogeniser 46.

While various operating pressures may be utilized, the high-pressure homogeniser 46 is preferably operated at pressures of about 50 to 400 bar. With the present invention, cell disruption occurs in a lower pressure range as compared with known implementations, i. e. in the pressure range of approximately 100 to 200 bar. In some embodiments, the pressure range of the homogeniser is operated at an even lower range so long as the shear forces applied to the microorganisms are sufficiently large to break up the cellular walls thereof.

A positive energy balance of this invention can be attained by targeting the influence on the high-concentration of the sludge with the decanter 38 and by classification using the classifying device 42. In this way, the possible energy yield from generated methane gas provides greater energy than can be used up by the disruption step in the process.

The positive energy balance can be attained by concentrating the wasted sludge by a factor of at least 1.5 and by using a high-pressure homogeniser 46 at a relatively lower pressure range for cell disruption as compared to known disruption pressures. The method can be further optimised if the biologically activated sludge is mixed with primary sludge before the concentration and disruption steps. Thereby, digestion of the sludge and thus the resultant gas yield are increased.

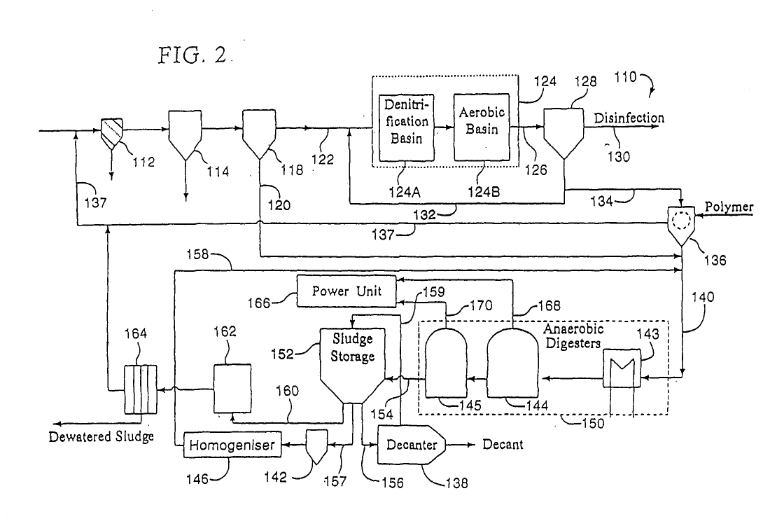

FIG. 2 shows an alternative embodiment of a wastewater treatment facility 110 according to the present invention, although somewhat similar to the process and system shown in FIG. 1. In this embodiment, raw wastewater initially passes through the bar screen 112 and sand collection device or grit classifier 114 before emptying into a prepurification or primary sedimentation tank 118. The prepurification tank 118 utilizes gravity settling to separate the heavy sediments (primary sludge) from the wastewater. Thus, for a treatment plant with an average raw wastewater inflow of about 2.15 million gallons per day (mgd), primary sludge may be generated at a rate of about 3,000 pounds per day (lbs/d) solids.

In accordance with one particular implementation of the invention, the sludge may be further pretreated prior to disruption or digestion with enhanced removal of heavy metals from the sludge. In FIG. 2, the classifier 114 may accomplish such enhanced heavy metal removal through methods such as the addition of vegetable oil or other suitable substance. Such removal improves methane gas production since heavy metals are generally toxic to the microorganisms in the sludge. However, the methodology used for heavy metal removal preferably does not itself materially effect the microorganisms in the sludge. This feature advantageously permits dewatered sludge exiting the system to be used as manure or in other agricultural applications without causing ecological damages.

The water discharged from the tank 118, called primary effluent, is passed along a flow path 122 to an aerobic digestion section 124. In this embodiment, the aerobic section 124 consists of a denitrification basin 124A and a stimulated (or aerobic) basin 124B. The denitrification basin 124A is operated under anoxic, or oxygen-reduced conditions, which enhances denitrifying bacteria in the removal of nitrates from the wastewater. Otherwise, the release of nitrates to the environment leads to the eutrophication of lakes and streams as well as the pollution of potable water supplies. Following denitrification, the wastewater enters the aerobic zone 124B where oxygen is delivered to enhance aerobic micro-organisms in the removal of organic material in the wastewater. The mixture of wastewater with a seed of aerobic micro-organisms is referred to as mixed liquor.

Following treatment in the aeration tank 124, the mixed liquor empties via a flow path 126 into a settling tank(s) 128 for clarification. Clarification utilizes flocculation and gravity settling to separate the water phase from the suspended solids and particulates. This water phase may be directed to a disinfection process along a flow path 130 before release, as will be understood by those skilled in the art.

In the embodiment shown in FIG. 2, a portion of the activated sludge stream exiting the settling tank(s) 128 is returned back to the aerobic digestion section 124 along the return flow path 132 for reseeding the system. The remaining sludge stream is directed along a flow path 134 to a sludge concentrator or thickener 136. In one embodiment, for raw wastewater supplied at an average inflow of 2.15 mgd that requires a biochemical oxygen demand of about 214 milligrams per liter (mg/l), the treatment wastes biologically activated sludge at a rate of approximately 1,000 Ibs/d solids. The sludge thickener or sieve 136 typically intermixes the activated sludge with a polymer to enhance the coagulation of the sludge and to aid in the removal of excess water. In one embodiment, the sieve 136 increases the solids concentration of the activated sludge by a factor between about 8 to 15. As shown in FIG. 2, the recovered water may be returned to the headworks of the facility along a path 137.

Following sludge concentration, the concentrated, activated sludge is directed along a flow path 140 to a heat exchanger 143 and a pair of digester tanks 144 and 145. Thus, the digester 150 implemented in the embodiment shown in FIG. 2 uses a two-phase digestion process, in the form of primary and secondary digester tanks, to optimise anaerobic digestion and the collection of methane gas. Those skilled in the art will appreciate, however, that this embodiment provides similar benefits to single phase anaerobic digestion. The concentrated, activated sludge is preheated by the heat exchanger 143 to an elevated temperature that will sustain anaerobic decomposition in the digester 144.

When the digestion process is completed, the digested sludge is transferred to a storage tank 152 along a flow path 154. The stored, digested sludge preferably undergoes a circulation process of decant, disruption and/or digestion as it exits the sludge storage tank 152. This circulation process optimises the generation of bio-gas from the sludge. This circulation process may be continuous or discontinuous. In one preferred embodiment, the stored, digested sludge is initially transferred from the storage tank 152 along flow path 156 to a decanter 138. Thereafter, decanter 138 further concentrates the sludge to an adequate concentration of solids, as with the embodiment described above. This concentrated sludge is recirculated back to the storage tank along a flow path 159. In this way, the desired concentration level of the sludge in the storage tank may be achieved. Alternatively the solids stream leaving the decanter may be routed directly to the classifier 142.

Decanted water obtained in the decanter 138 is returned to the inlet of the wastewater treatment system. After the digested sludge is adequately concentrated, at least a partial stream of the concentrated, digested sludge is drawn from the storage tank 152 along flow path 157 for disruption of the microorganisms. For example, concentrated, digested sludge may be drawn from the sludge storage tank 152 for disruption at a flow rate of about 0.2 percent of the combined flow rate of primary sludge and biologically activated sludge supplied to the digester(s) 150. As shown in FIG. 2, the concentrated, digested sludge passes through a classifier 142 and a high-pressure homogeniser 146 in the same manner as described in conjunction with FIG. 1.

The disrupted sludge exiting the homogeniser 146 travels along flowpath 158, where the sludge is re-heated by the heat exchanger 143. The disrupted sludge may be mixed with primary sludge from the pre-purification tank 118 and/or biologically activated sludge provided from the sieve 136. Although not shown in FIG. 2, this sludge mixing may also occur prior to homogenisation using the high pressure homogeniser 146. The sludge is thereafter returned to the anaerobic digestion system 150.

Periodically, sludge is removed from the storage tank 152 along flowpath 160 for disposal. Typically, the sludge is further dewatered by a combination sludge conditioner 162 and filter 164 before it is ready for disposal by incineration or by depositing on agricultural fields and/or landfill. In one preferred embodiment, the combination sludge conditioner 162 and filter 164 increases the solids concentration in the sludge by a factor of at least 3.

FIG. 2 also shows a power conversion unit 166 disposed to recover methane gas provided by the digester tanks 150 along the flow paths 168 and 170. For a treatment plant supplying a combined primary, secondary sludge, and disrupted sludge flow of 53 cubic meters per day (m3/d) AT 3.4 percent solids to the anaerobic digesters 150, the anaerobic digesters 150 may be expected to recover bio-gas in the range of 800 cubic meters per day with a 64 percent volume of methane. Of course, methane generation will vary depending on the percentage of volatile organic solids in the digested sludge as will be understood by this skilled in the art. Through the conversion process performed by the power conversion unit 166, an additional source of energy is available for use by the disruption system as well as other parts of the wastewater treatment facility.

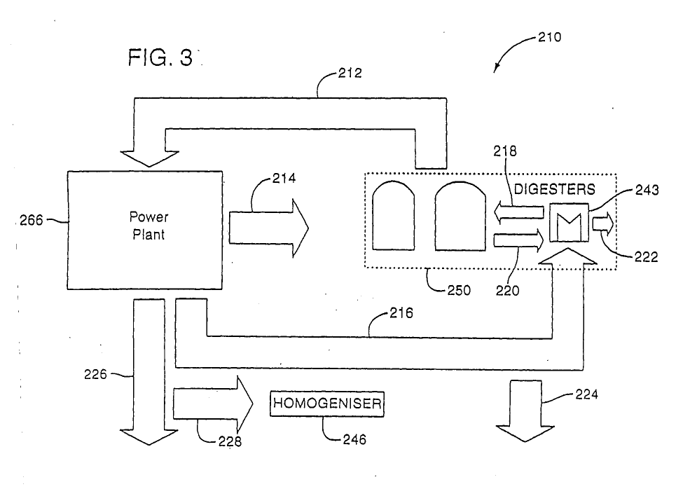

FIG. 3 illustrates a flow diagram of the energy balance that may be obtained according to the present invention. As explained below, a greater energy per sludge solids processed may be achieved as compared to state of the art sludge treatment methods.

In FIG. 3, arrows are used to denote the flow of energy in the various portions of a treatment system 210 according to an embodiment of the present invention, as measured in kilowatt-hours per kilogram total solids (kWh/kg TS). The energy content of the biological gas, or methane gas, produced by the digester towers 50, 150 in the embodiments shown in FIGS. 1 and 2 is provided to a combined power conversion plant 266 for the system, as denoted by the arrow 212. In one preferred embodiment, this energy is in the range of 2.5 kWh/kg TS, as compared with 2 kWh/kg TS in systems known in the prior art.

The power plant 266 operates to convert the bio-gas supplied from the digester towers to a usable form of energy. In this conversion process, a certain amount of energy is expected to be lost, as represented by the arrow 214. In one preferred embodiment, this energy loss is in the range of 0.3 kWh/kg TS. The rest of the converted energy can be utilized to self-sustain operation of the treatment system.

There are various energy requirements for operation of the digestion apparatus. For example, the energy required to maintain a proper temperature of a heat exchanger 243 for heating the digested sludge as part of the digestion process is denoted in FIG. 3 as arrow 216, which in a preferred embodiment is in an expected energy range of about 1.2 kWh/kg TS. This permits the digester section 250 to operate at a temperature in the range of 98 to 102 F, as is desirable when optimising the anaerobic digestion of the sludge. Of course, heat will be transferred from the heat exchanger to the digester section. This transfer of energy is denoted in FIG. 3 as arrow 218, about 0.8 kWh/kg TS. Similarly, energy losses, such as through transmission, will occur in the digester section. These losses are denoted by arrow 220, and are on the order of about 0.2 kWh/kg TS. The heat loss based on sludge discharge of the heat exchanger is denoted by arrow 222, and is on the order of about 0.6 kWh/kg TS. Finally, excess heat losses in the system are denoted by arrow 224, and are on the order of about 0.1 kWh/kg TS.

As explained above, the combined power conversion plant generates electrical energy, as denoted by the arrow 226. In a preferred embodiment, the amount of generated electrical energy is about 0.8 kWh/kg TS.

For disrupting sludge, a portion of the generated electrical energy is required, i. e., to operate the homogeniser pump 246. In one embodiment, this energy requirement is denoted by the arrow 228 (e. g. 0.2 kWh/kg TS at 100 bar) That is, the system requires this energy in order to operate the high pressure homogeniser 246 shown in FIG. 3. Of course, any excess generated energy may be utilized in other aspects of the treatment system.

According to an embodiment of the present invention, a 25 percent increase in energy content value may be achieved as compared to state of the art methods. That is, the energy content of the bio-gas generated according to an embodiment of the present invention is 2.5 kWh/kg TS, as compared to 2 kWh/kg TS using state of the art disruption methods. As a result, the invention permits sufficient energy for self-sustaining disruption of the sludge, as well as providing excess energy for use elsewhere, as compared to state of the art sludge treatment methods.

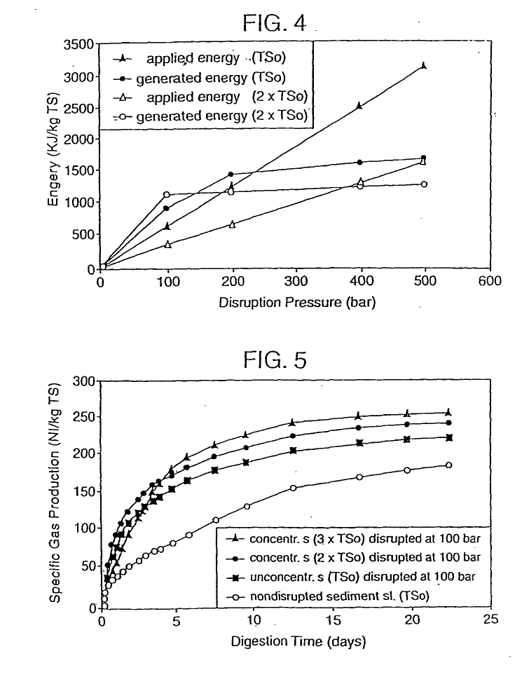

FIG. 4 shows a diagram in which the energy balance is plotted upon disruption using a high-pressure homogeniser, operated at pressures of 0 to 500 bar. This diagram illustrates applied energy and generated energy for sludge having different concentrations. As can be seen, when the homogeniser according to an embodiment of the invention is operated at a pressure of approximately 200 bar, the applied energy is lower than the generated energy. Thus, in this range, the energy balance is positive. The curves marked with a white triangle or white dot apply to highly concentrated sludge that has been concentrated by a factor of 2. The diagram shows that the applied energy for concentrated sludge also lies below the applied energy for non-concentrated sludge. On the other hand, the generated amount of energy, i. e., the amount of generated methane gas, up to a homogeniser pressure of 200 bar, is greater for concentrated sludge as compared to the generated energy from non-concentrated sludge. The energy balance for concentrated sludge is positive in the homogeniser pressure range of 0 to 400 bar. The largest energy surplus results at a homogeniser pressure of 100 bar.

FIG. 5 shows a diagram in which the specific gas production from samples of untreated sludge, disrupted sludge at normal concentration and concentrated sludge (by factors of 2 and 3) is plotted over a period of time. In this case, the observation period is 23 days. As shown, the untreated sludge provides a considerably less methane gas than disrupted sludge. The curve plot of the gas production runs exponentially. The double concentrated sludge produces somewhat more gas than the non-concentrated sludge. The gas curves run almost parallel. It is noticeable that the triple-concentrated sludge produces less gas in the first four days than the less concentrated sludge. The triple-concentrated sludge, however, subsequently reaches its microbiological stability and produces more gas than in the decomposition of less concentrated sludge. The disruption process used in these performance analyses was carried out using a high-pressure homogeniser operated at 100 bar.

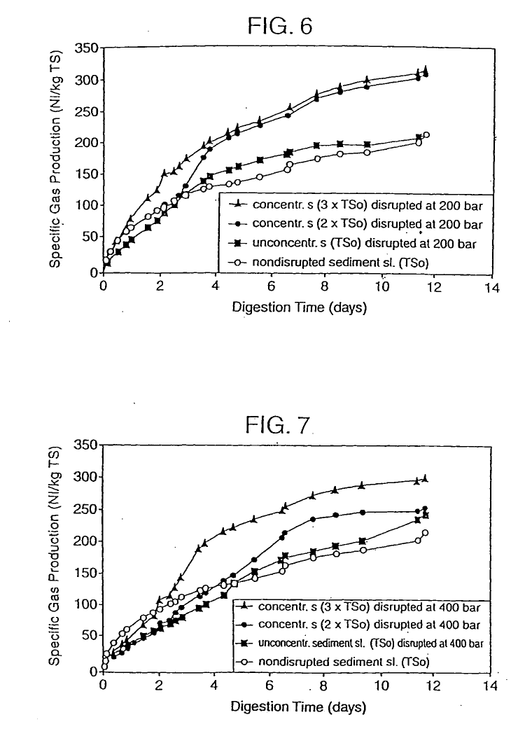

FIG. 6 illustrates test results carried out at a homogeniser pressure of 200 bar. As shown, the gas production of unconcentrated, non-disrupted sludge is almost identical to the non-concentrated disrupted sludge. Thus, by mere disruption, a higher gas yield is generally not achieved. A comparison with the gas production shown in FIG. 5 shows that when using a high-pressure homogeniser at 200 bar, the gas yield is not much higher than at a homogeniser pressure of 100 bar.

FIG. 7 is a diagram comparable with FIGS. 5 and 6, but operating the high-pressure homogeniser at a pressure of 400 bar. It can be seen that when disruption occurs at a pressure of 400 bar, the gas yield is only be increased by concentrating at a factor of at least 3, in comparison to a homogeniser pressure of 100 bar. A comparison with the test result at 200 bar, which is shown in FIG. 4, shows that the gas yield cannot be further improved with increased homogeniser pressure.

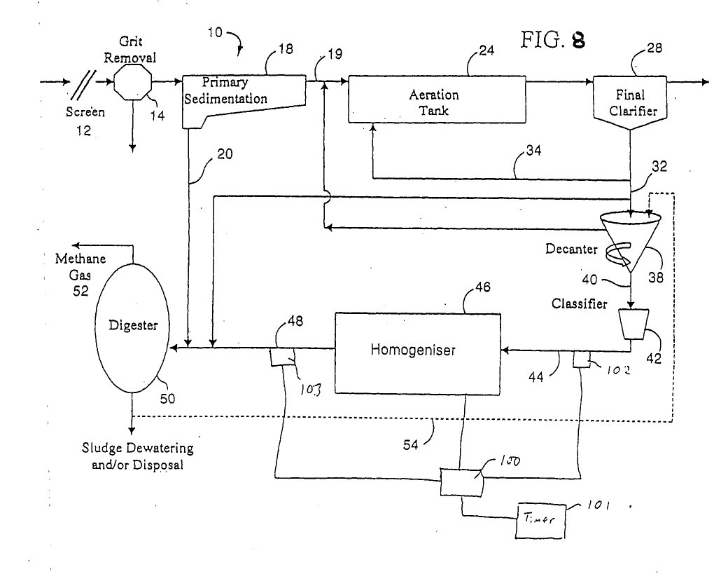

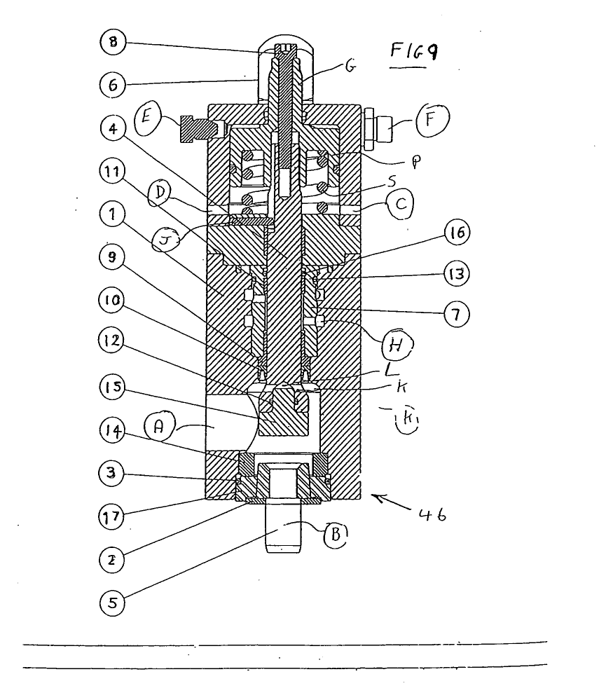

With respect to another embodiment of the present invention, illustrated with reference to FIGS. 8 and 9, the homogeniser valve 46 (see FIG. 9) comprises an inlet port (B) and outlet port (A) through which wastewater is able to flow for homogenisation, via a gap defined between the annular valve seat (2) and end portion (15) of an axially moveable control rod (4). The end portion (15) of the control rod is selectively removable by moving the rod (4) downwards as viewed in FIG. 9 such that a tool may inserted through the outlet (A) to engage with a conical end region (L) of the end member (15) and thereby urge the part (15) away from the rod (4).

In normal use the end face of the closure member (15) lies at a spacing of 0.03 mm from the valve seat (2) and is held in that position by virtue of hydraulic pressure applied via inlet (F) to an annular chamber at one end of a piston (P) to which the rod (4) is secured via a screw threaded adjustment screw (8) operable to permit variation and locking of the axial position of the piston (P) relative to the rod (4}. If the hydraulic pressure applied through (F) is removed, by venting through exhaust (E), the piston is urged upwards, as viewed in FIG. 9, by the action of the coil spring (S) thereby to retract the valve closure member (15} from the valve seat (2), and in this embodiment to create a gap in the order of 10 mm.

End (15) is removably located in the end of the rod (4), and can be replaced by first inserted a tool, such a small screwdriver, in the passage (K) via the outlet port (8) to act against the frustoconical surface (1), thus creating a gap between the end of the rod and confronting abutment shoulder of the closure member {15) to enable insertion of a tool and removal of the closure member (15) for replacement following wear.

Operation of the homogeniser valve (46) is controlled by a control unit (100) having associated therewith a timer (101}. In normal use the control unit (100) is arranged to ensure a supply pressurised hydraulic fluid to the inlet (F} and to maintain in a closed condition a valve (not shown) in the exhaust from outlet {E). Thus pressurised fluid acting on the hydraulic piston ensures that the closure member is positioned to create just a small gap for homogenisation. Under the action of the timer (101) the supply of hydraulic pressure is terminated every 15 minutes for a period of approximately 10 seconds, the valve in exhaust line (E) being opened for that purpose. In consequence of the action of spring(s) there thus results an opening of the gap between the closure member (15) and valve seat (2), a gap of approximately 10 mm being achieved to allow flushing away of any particles that may have accumulated and caused a blockage.

In addition to movement of the valve to a relatively open position under the action of the timer, on a periodic, regular basis, the valve may additional be operated for example by the control unit detecting via a pressure sensor (102) that an unduly high pressure is present in the supply line (44) to the homogeniser, indicating a potential blockage, or by a relatively low flow rate being detected by a flow meter (103) in the outlet from the homogeniser, that similarly indicating a blockage.

Various advantages flow from the invention. As waste treatment facilities have always been conditioned to obtain improved cost savings, the methodology and system according to the present invention provides a business model that meets such an expectation. That is, the waste treatment facility provides an energy balance that is achieved through careful optimisation of the applied energy as compared to the energy generated therefrom.

Illustrative embodiments of the present invention and certain variations thereof have been provided in the Figures and accompanying written description. However, those skilled in the art will readily appreciate from the above disclosure that many variations to the disclosed system and methodology are possible without deviating from the breadth of the disclosed invention. The variations include, without limitation, partial or substantially complete disruption of the microorganisms in the sludge with the use of appropriate mixing means, ultrasonic homogenizing means or like apparatus that achieve a similar (or the same) degree of disruption of the microorganism walls as compared with a homogeniser valve.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for treatment of particle bearing liquid comprising control means and an homogeniser valve, said control means being operable to cause a gap defined by the homogeniser valve to be periodically temporarily increased to a relatively open position thereby to allow any accumulated particulate matter to pass through the valve, the valve then continuing to provide an homogenisation of subsequently flowing liquid when the valve returns to a normal position in its normal mode of operation.

2. The system of claim 1, wherein the control means causes the valve to open temporarily to allow passage of any accumulated particulate material for a period which is less than 10% of the period for which the valve operates in a normal mode.

3. The system of claim 2, wherein the period for passage of accumulated particulate material is less than 5% of the period of operation in the normal mode.

4. The system of claim 1, wherein the ratio between the gap defined by the valve in the relatively open position and that in the normal operating position for homogenisation is at least 100:1.

5. The system of claim 4, wherein said ratio is at least 200:1.

6. The system of claim 1 further comprising a macerator from which liquid flows to the homogeniser valve, the gap provided by the valve when moved to said relatively open position being at least 10% greater than the maximum size to which the macerator chops particulate material.

7. The system according to claim 6, wherein said percentage is at least 25%.

8. The system of claim 1, wherein the valve is movable by an hydraulic or pneumatic actuator.

9. The system of claim 8, wherein the actuator is integral with the valve.

10. The system of claim 1 further comprising a sensor in the flow path to and or from the homogeniser valve and operable to detect the presence or onset of a blockage and cause temporary opening of the valve.

11. The system of claim 1, wherein the valve is moved to said relatively open position on a regular basis at fixed intervals of time.

12. A method for treatment of particle bearing liquid, said method comprising use of an homogeniser valve and causing the gap defined by the homogeniser valve periodically to increase temporarily thereby to allow any accumulated particulate matter to pass through the valve, the valve then continuing to provide an homogenisation of subsequently flowing liquid when the valve returns to its normal mode of operation.

13. The method of claim 12, wherein the valve is opened to allow a passage of any accumulated particulate material for a period which is less than 10% of the period for which it has been operating in a normal mode.

14. The method of claim 13, wherein said period percentage is less than 5%.

15. The method of claim 12, wherein a sensor is provided in the liquid flow path to or from the homogeniser valve and information from said sensor is employed to detect the presence or onset of a blockage.

16. The method of claim 12, wherein control means is employed to cause the valve to be moved to said relatively open position on a regular basis at fixed intervals of time.
